(19) United States
(12) Patent Application Publication
(10) Pub. No.: US 2011/0097052 A1
(43) Pub. Date: Apr. 28, 2011

(54) Fiber Access Terminal Mounted at a Mid-Span Access Location of a Telecommunications Cable

(76) Inventors: James J. Solheid, Lakeville, MN (US); Oscar Fernando Bran de León, Belle Plaine, MN (US)

(21) Appl. No.: 12/909,368

(22) Filed: Oct. 21, 2010

Related U.S. Application Data
(60) Provisional application No. 61/253,723, filed on Oct. 21, 2009.

(51) Int. Cl. G02B 6/00

(52) U.S. Cl. 385/135

(57) ABSTRACT

A fiber optic access terminal includes an enclosure defining a top side, a bottom side, a right side, a left side, and a main body with an open front side and a rear wall, the enclosure also including a front cover for opening and closing the open front side. A cable entrance/exit opening is positioned on the main body. At least one fiber optic adapter is mounted on the right side of the enclosure and at least one fiber optic adapter is mounted on the left side of the enclosure. Each of the right and left adapters extend rightwardly and leftwardly, respectively, from inside the enclosure toward the outside. The adapters also extend downwardly in a direction extending from the top of the enclosure toward the bottom. A cable management structure is defined between the right adapter and the left adapter, the cable management structure including a first spool that cooperates with the top side, the bottom side, the right side, and the left side to define a first space extending all the way around the first spool for managing fiber optic cables within the enclosure.

### CROSS REFERENCE TO RELATED APPLICATION

This application claims the benefit of U.S. Provisional Patent Application Ser. No. 61/253,723, filed Oct. 21, 2009, which application is hereby incorporated by reference in its entirety.

### TECHNICAL FIELD

The principles disclosed herein relate to fiber optic cable systems. More particularly, the present disclosure relates to fiber optic cable systems for providing fiber to the premises.

### BACKGROUND

Passive optical networks are becoming prevalent in part because service providers want to deliver high bandwidth communication capabilities to customers. Passive optical networks are a desirable choice for delivering high speed communication data because they may not employ active electronic devices, such as amplifiers and repeaters, between a central office and a subscriber termination. The absence of active electronic devices may decrease network complexity and/or cost and may increase network reliability.

### SUMMARY

Certain aspects of the disclosure relate to a fiber access terminal for use in a fiber optic network. The fiber access terminal can include structure that facilitates mounting the fiber access terminal at a mid-span access location of a fiber optic cable.

A variety of additional aspects will be set forth in the description that follows. The aspects can relate to individual features and to combinations of features. It is to be understood that both the forgoing general description and the following detailed description are exemplary and explanatory only and are not restrictive of the broad concepts upon which the embodiments disclosed herein are based.

### BRIEF DESCRIPTION OF THE DRAWINGS

FIG. 1 shows an example passive fiber optic network in accordance with the principles of the present disclosure;

FIG. 2 is a front perspective view of a fiber access terminal in accordance with the principles of the present disclosure, the fiber access terminal configured for use in the passive fiber optic network of FIG. 1;

FIG. 3 is a front view of the fiber access terminal of FIG. 2;

FIG. 4 is a right side view of the fiber access terminal of FIG. 2;

FIG. 5 is a left side view of the fiber access terminal of FIG. 2;

FIG. 6 is a top view of the fiber access terminal of FIG. 2;

FIG. 7 is a bottom view of the fiber access terminal of FIG. 2;

FIG. 8 illustrates a front perspective view of the fiber access terminal of FIG. 2 with the cover of the terminal in an open position;

FIG. 9 illustrates an exploded front perspective view of the fiber access terminal of FIG. 2, with a cable retainer and one of the fiber optic adapters exploded off the main body;

FIG. 10 illustrates a front view of the fiber access terminal of FIG. 2 with the cover of the terminal in the open position;

FIG. 11 is a cross-sectional view taken along line 11-11 of FIG. 10;

FIG. 12 is a front view of the fiber access terminal of FIG. 2 illustrating an example cable routing configuration for two of the connectorized cables branched off from the main cable, wherein the two connectorized cables are coupled to two hardened fiber optic adapters;

FIG. 13 illustrates a perspective view of the fiber access terminal of FIG. 2 with the cover in the open position showing an example cable routing configuration for all four of the connectorized cables branched off from the main cable, wherein all four of the connectorized cables are coupled to hardened fiber optic adapters;

FIG. 14 illustrates the fiber access terminal of FIG. 13 from a front view thereof;

FIG. 15 is a front view of the main body of the fiber access terminal of FIG. 2;

FIG. 16 is a rear view of the main body of FIG. 15;

FIG. 17 is a right side view of the main body of FIG. 15;

FIG. 18 is a left side view of the main body of FIG. 15;

FIG. 19 is a top view of the main body of FIG. 15;

FIG. 20 is a bottom view of the main body of FIG. 15;

FIG. 21 is a front view of the cover of the fiber access terminal of FIG. 2;

FIG. 22 is a rear view of the cover of FIG. 21;

FIG. 23 is a right side view of the cover of FIG. 21;

FIG. 24 is a left side view of the cover of FIG. 21;

FIG. 25 is a top view of the cover of FIG. 21;

FIG. 26 is a bottom view of the cover of FIG. 21;

FIG. 27 is a front view of the cable retainer of the fiber access terminal of FIG. 2; and

FIG. 28 is a right side view of the cable retainer of FIG. 27.

### DETAILED DESCRIPTION

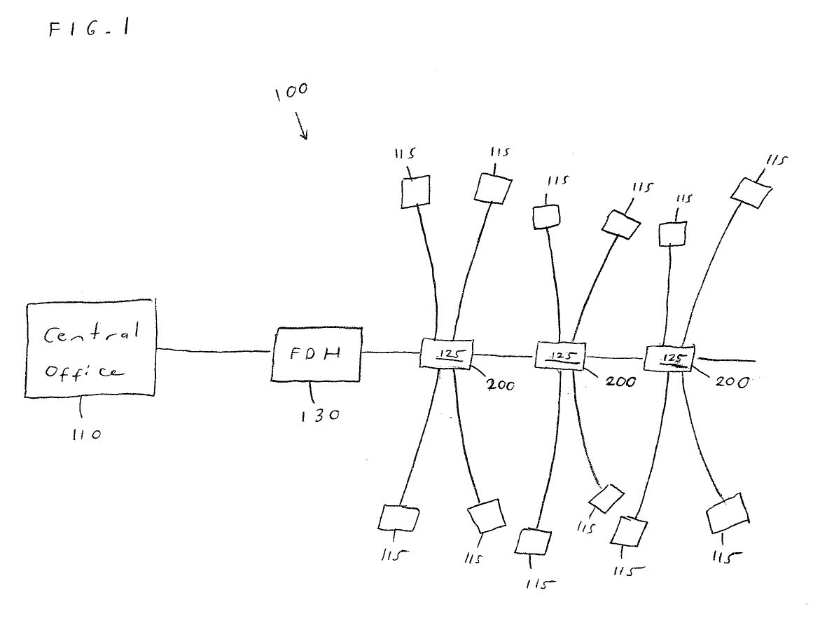

FIG. 1 illustrates a fiber optic network 100 deploying passive fiber optic lines. As shown in FIG. 1, the network 100 may include a central office 110 that connects a number of end subscribers 115 (also called end users 115 herein) in a network. The central office 110 may additionally connect to a larger network such as the Internet and a public switched telephone network. The network 100 may include fiber distribution hubs (FDHs) 130 having one or more optical splitters (e.g., 1-to-8 splitters, 1-to-16 splitters, or 1-to-32 splitters) that generate a number of individual fibers that may lead to the premises of an end user 115.

The cables going from the FHD 130 may include break-out locations 125 at which branch cables are separated out from main cable lines. Breakout locations 125 may be enclosed by field mounted enclosures (i.e., fiber access terminals) 200 which protects the optical couplings provided at the breakout locations 125. Since breakout locations are often provided at mid-span locations on the main cable being accessed, it desirable for the field mounted enclosures to be readily mountable at mid-span access locations. From the fiber access terminals 200, branch cables may extend to the end subscribers 115.

According to one example application of an optical network of the present disclosure, the cables going from the FDH 130 may be routed through and supported by a plurality of structures such as telephone poles. The telephone pole may be used as the mid-span access location for a breakout. Excess cable may normally be provided at those telephone poles that are going to be used as the breakout locations so that there is enough cable for the optical couplings to be performed at the breakout location. From one telephone pole, the branch cables may then extend to nearby end subscribers while the main cable continues to extend to the next telephone pole.

The present disclosure relates generally to fiber access terminals configured to be easily mounted at mid-span locations along the length of a fiber optic telecommunications cable. It is preferred for the fiber access terminals in accordance with the principles of the present disclosure to be used for outdoor applications. However, it will be appreciated that the fiber access terminals in accordance with the principles of the present disclosure can be used for either indoor or outdoor applications wherever it is desired to easily mount an enclosure at a mid-span location of a telecommunications cable.

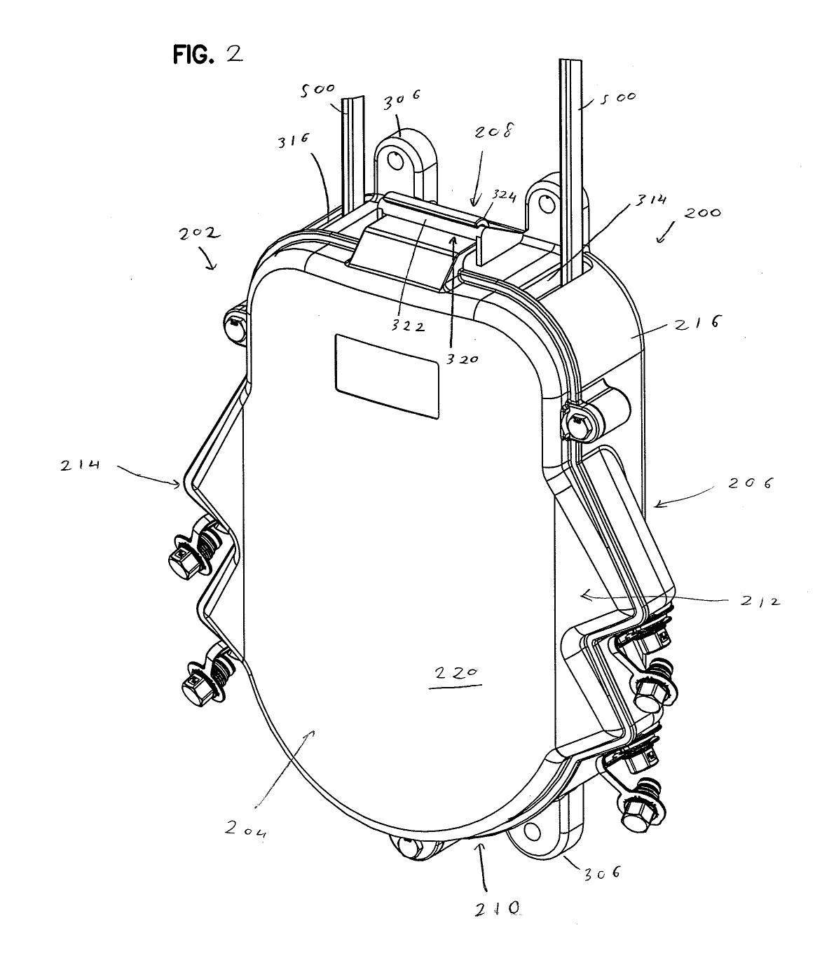

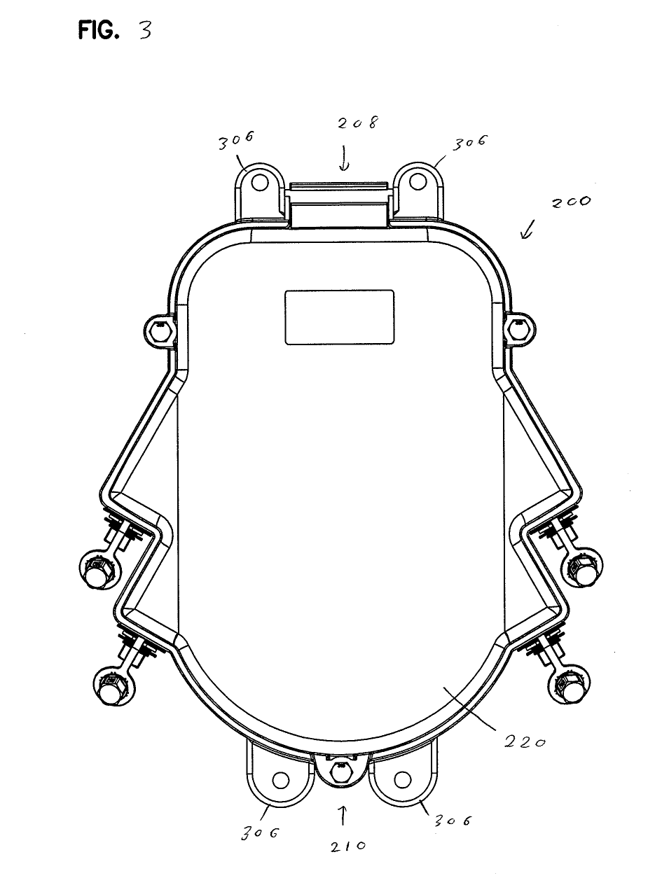

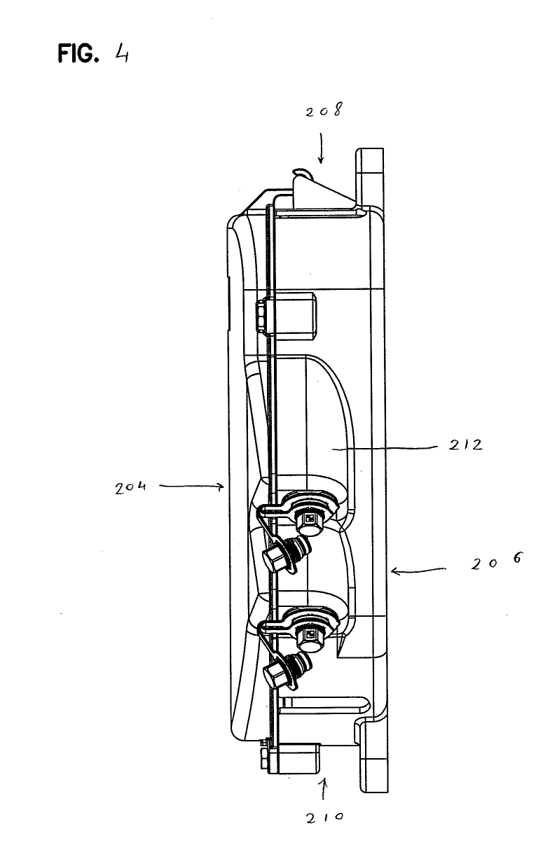

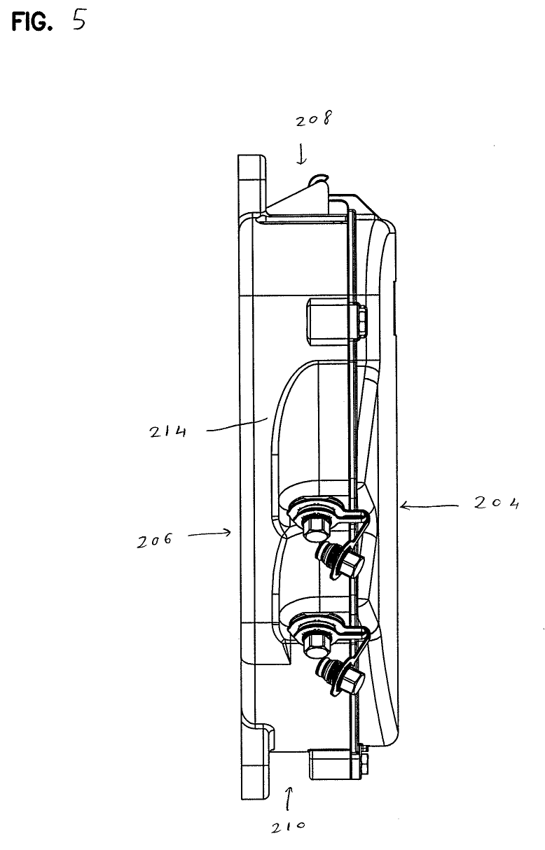

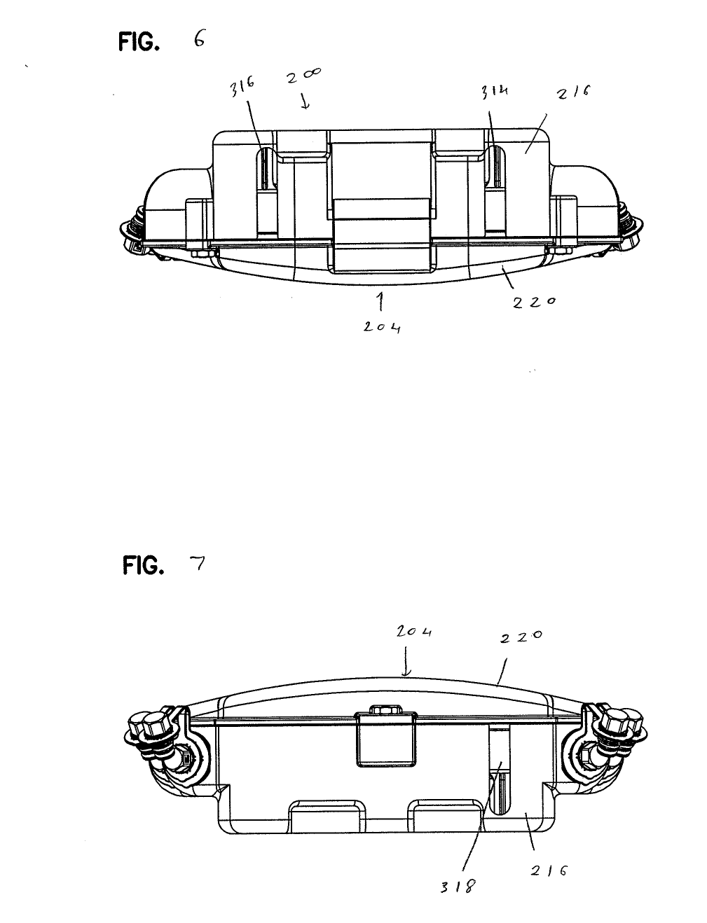

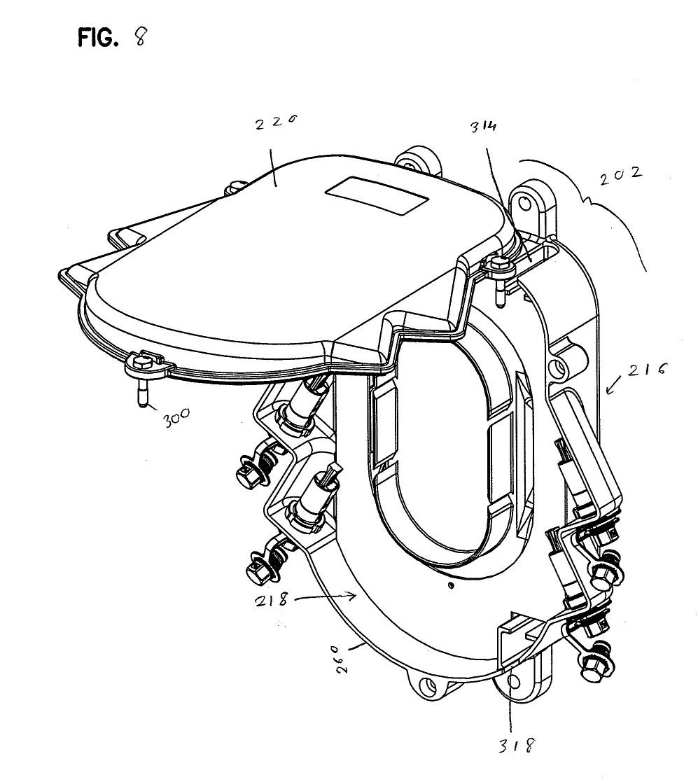

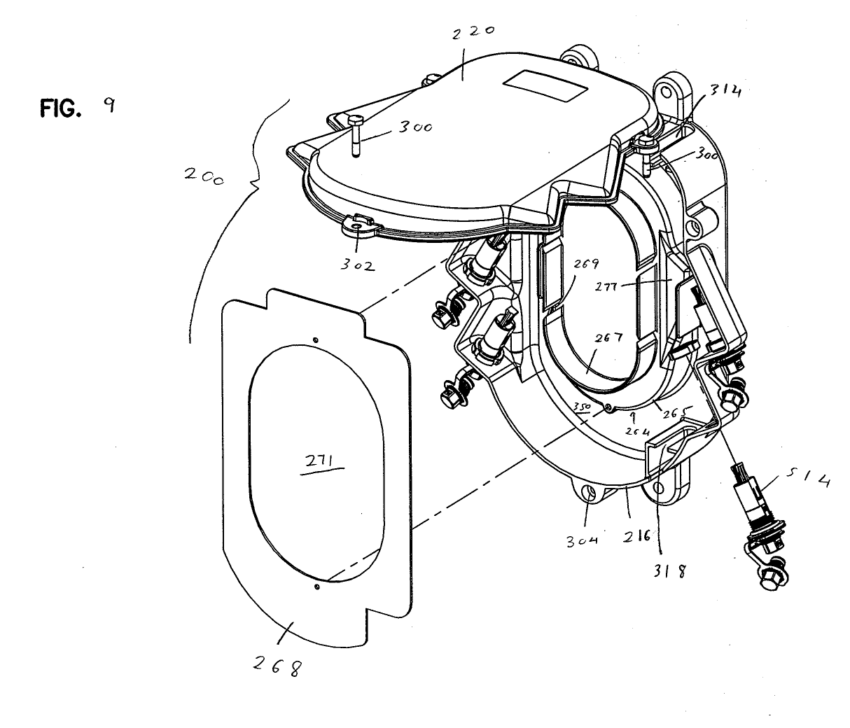

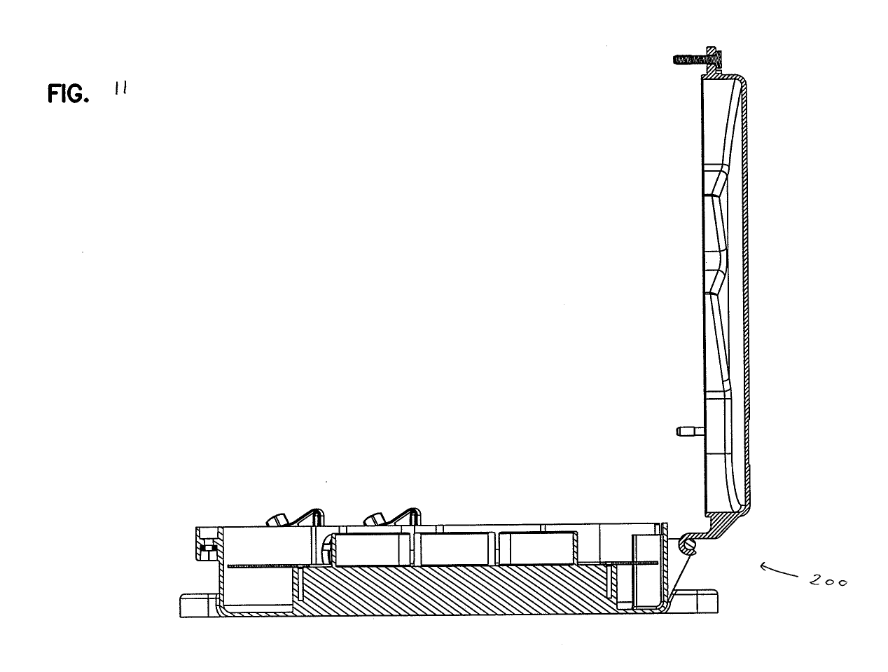

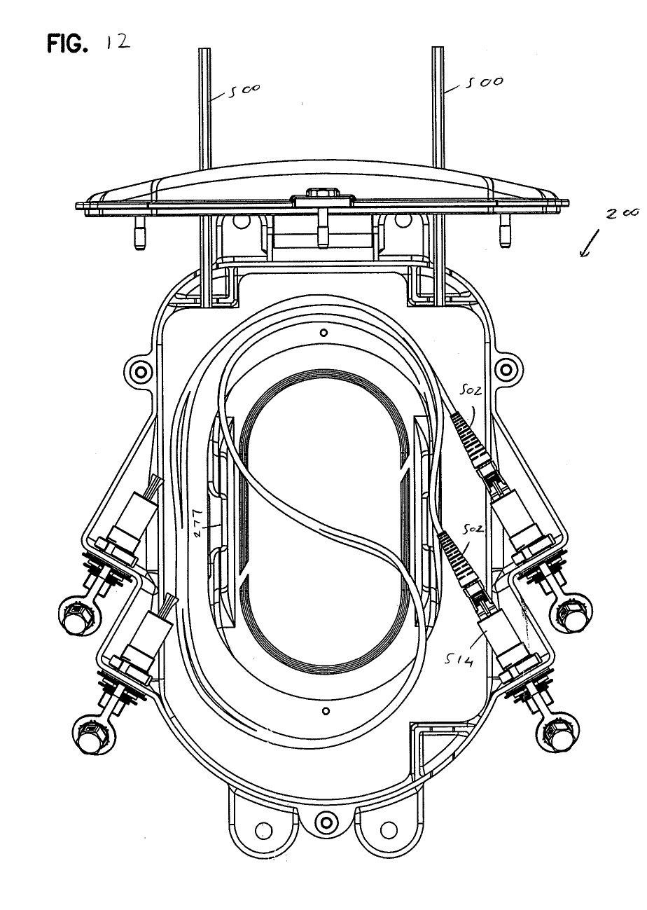

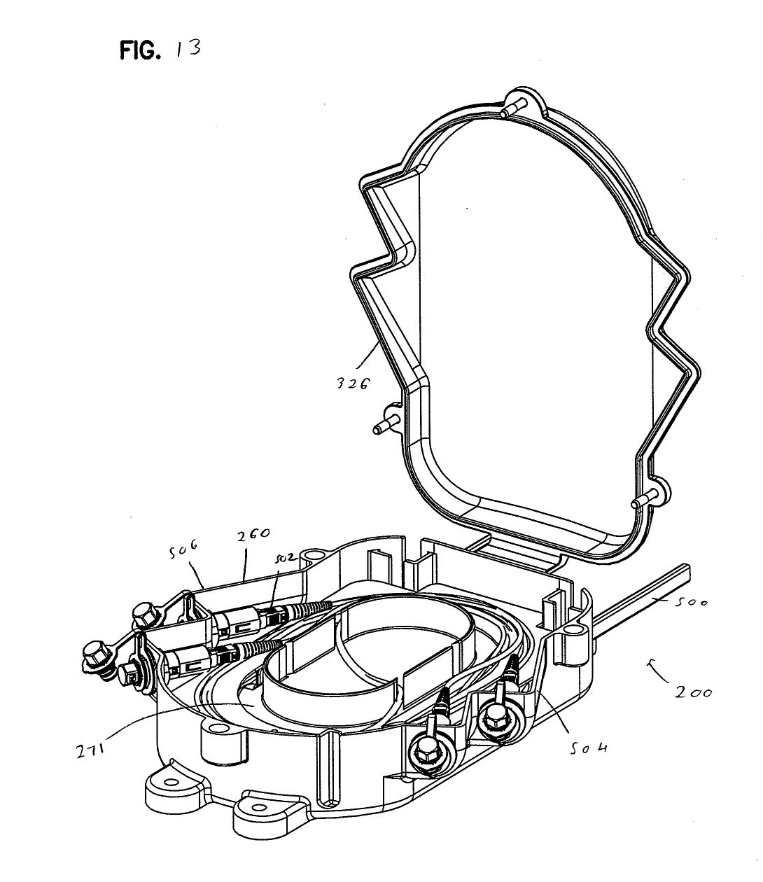

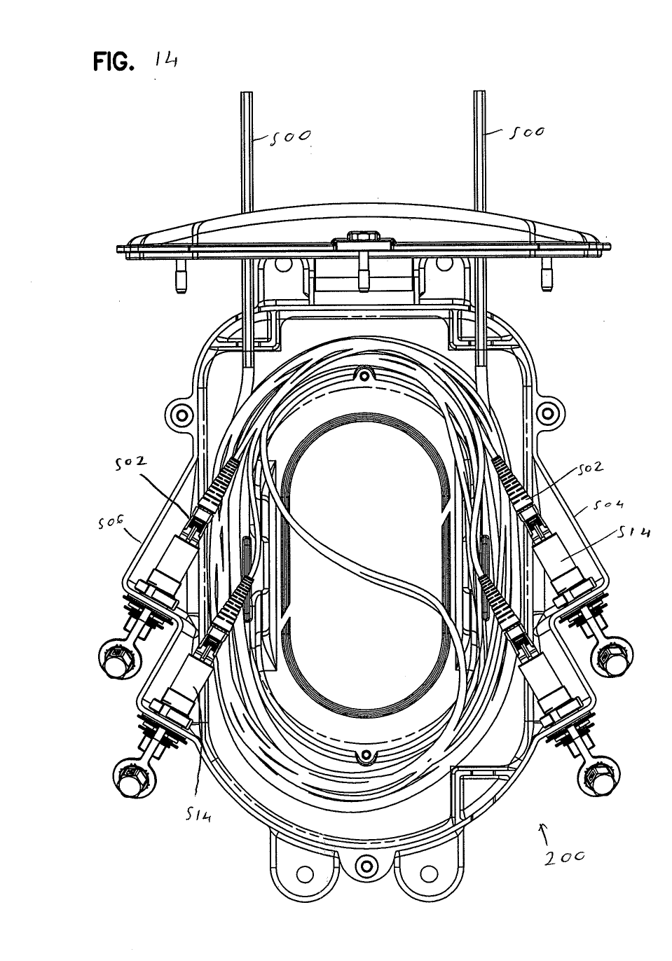

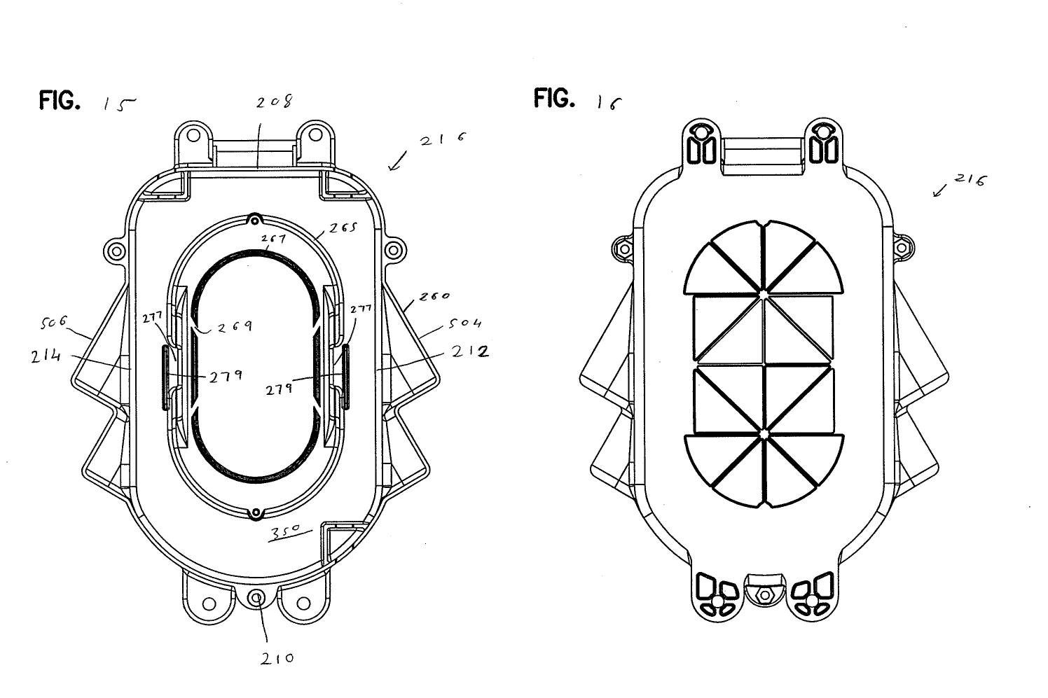

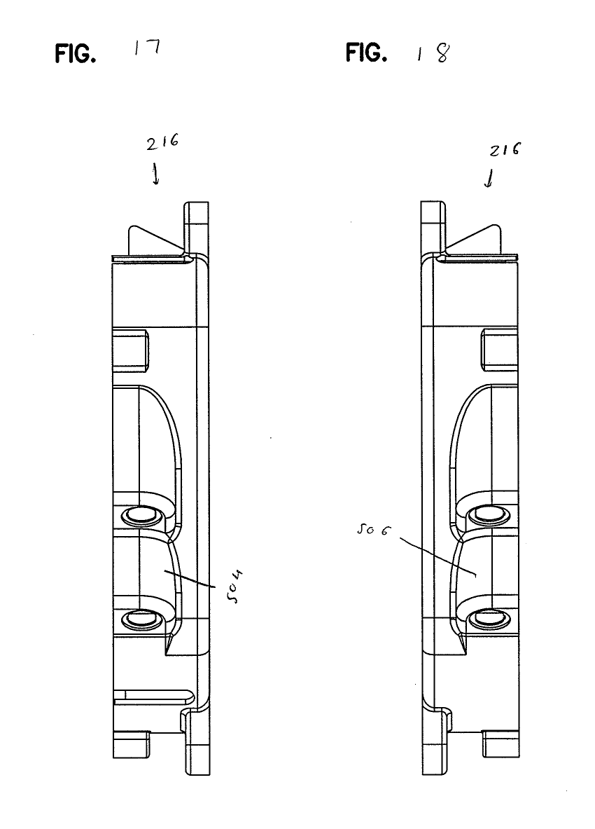

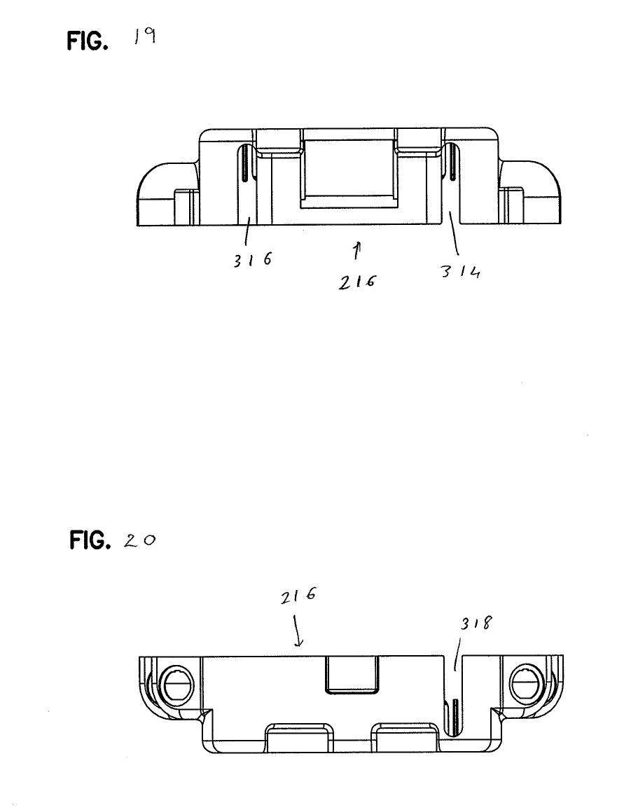

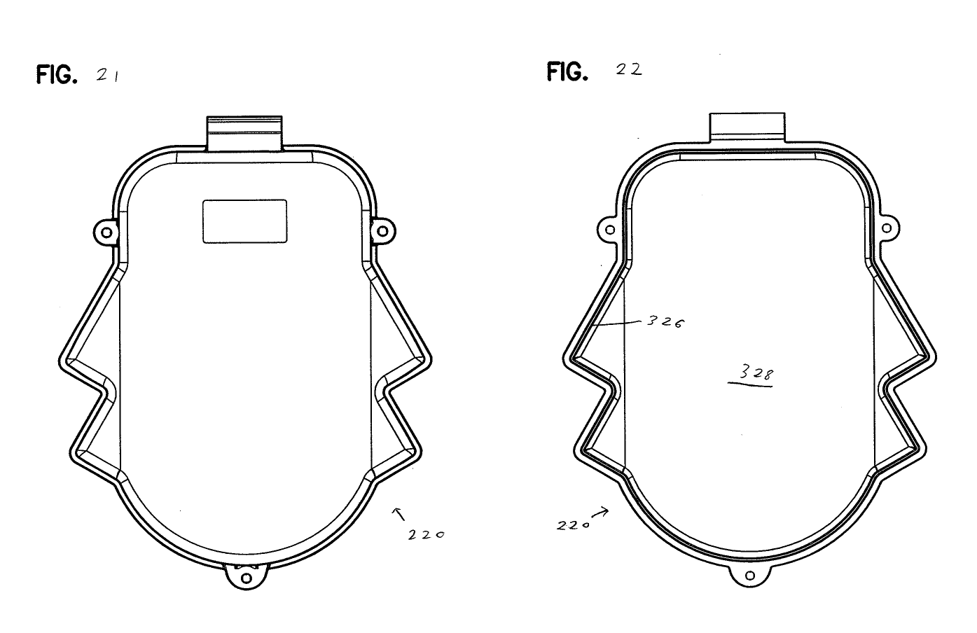

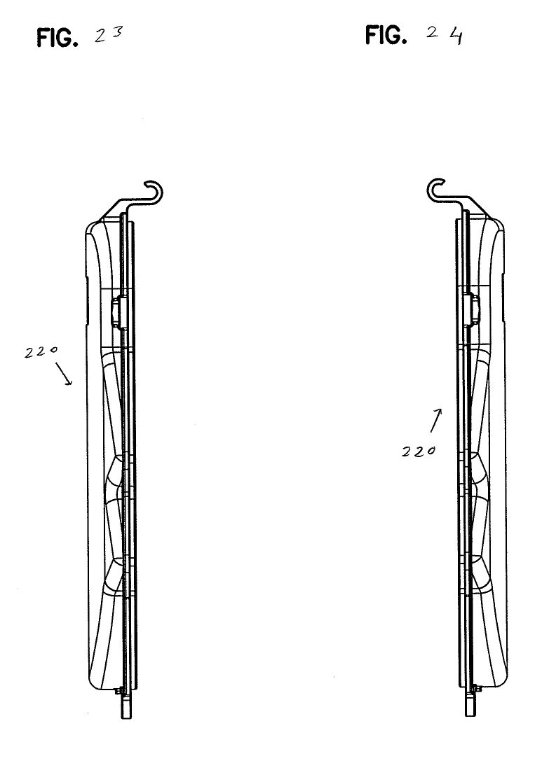

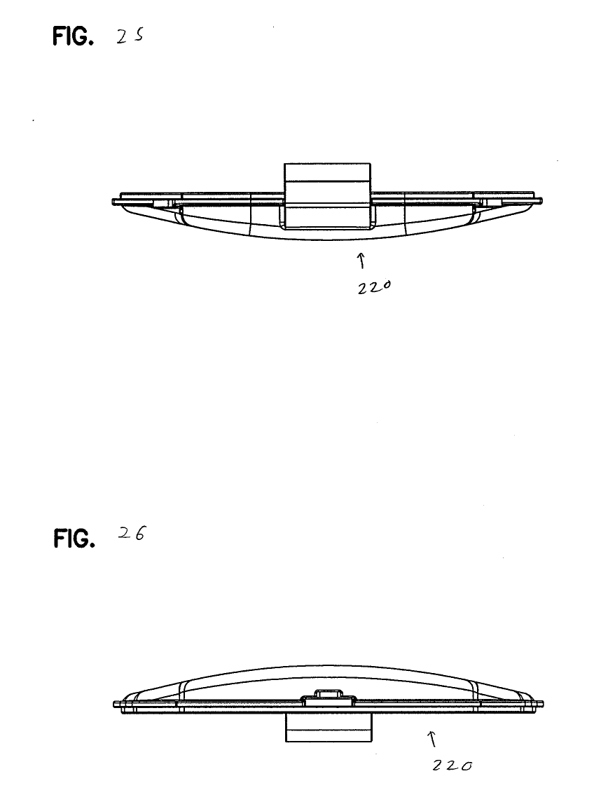

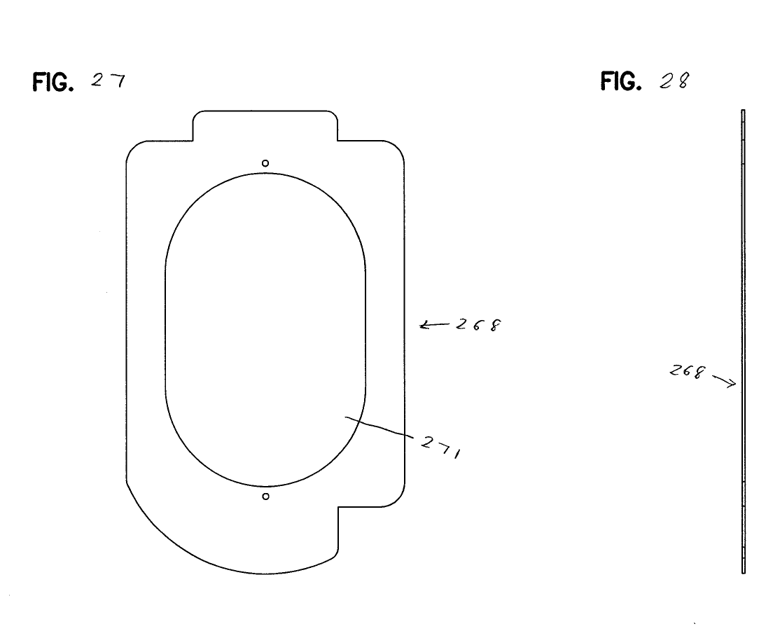

FIGS. 2-28 show a fiber access terminal 200 having features in accordance with the principles of the present disclosure. The fiber access terminal 200 includes a generally rectangular enclosure 202 including a front side 204, a back side 206, a top side 208, a bottom side 210, a right side 212 and a left side 214. The enclosure 202 includes a main body 216 defining an open front side 218. The main body 216 is shown in isolation in FIGS. 15-20 of the application. The enclosure 202 also includes a front cover 220 hingedly mounted to the main body 216. The front cover 220 is shown in isolation in FIGS. 21-26 of the application. The front cover 220 is movable between a first position (shown in FIG. 2) where the open front side 218 of the main body 216 is covered, and a second position (shown in FIG. 8) where the open front side 218 of the main body 216 is exposed so as to allow access into the interior of the enclosure 202 from the front side 204 of the enclosure 202. Once the front cover 220 is hinged shut, the cover 220 may be locked close using fasteners 300 extending through fastener openings 302, 304 located around the periphery of the cover 220 and of the main body 216, respectively.

The main body 216 also defines mounting structures 306 for mounting fiber access terminal 200 to another structure, for example, at a break-out location within a fiber optic network. According to one example, the mounting structures 306 (e.g., mounting flanges) may be used to mount the fiber access terminal 200 to a vertical structure such as a telephone pole. It is preferred for the fiber access terminal 200 to be configured to allow the terminal to be easily mounted to a vertical surface such as a pole. In certain embodiments, mounting flanges 306 integrally formed with the main body 216 allow the fiber access terminal 200 to be readily fastened to a pole or other structure. In still other embodiments, the fiber access terminal 200 can be used in combination with a separate bracket arrangement that is pre-mounted to a structure such as a pole and that receives or otherwise attaches to the fiber access terminal 200 to allow the fiber access terminal 200 to be readily mounted to the pole or other structure.

For ease of explanation, the various sides of the enclosure 202 have been described as being “top”, “bottom”, “right” and “left” sides so as to correspond with the orientation of the enclosure 202 shown at FIG. 2. However, it will be appreciated that when used in the field, the enclosure 202 can be mounted at any orientation. For example, if the distribution cable is routed horizontally, the sides 208, 210 would be oriented to define the left and right sides of the enclosure 202, and the sides 212, 214 would be oriented to define the top and bottom sides of the enclosure 202.

The main body 216 defines first and second cable enter/exit openings 314, 316 at the top side 208 and a third cable enter/exit opening 318 located at the bottom side 210 of the enclosure 202. The cable openings 314, 316, 318 allow the portions of the telecommunications cable located upstream and downstream of the mid-span access location to enter and exit the enclosure 202. The first cable exit/enter opening 314 and the third cable exit/enter opening 318 are generally co-axially aligned and positioned at top and bottom ends of the enclosure 202.

As shown best at FIG. 2, the front cover 220 is pivotally connected to the main body 216 at a horizontal pivot axis located generally adjacent the top end of the main body 216. The pivotal connection between the front cover 220 and the main body 216 is provided by a hinge arrangement 320 including a hinge pin 322 integrally formed with the main body 216 and a hinge pin receiver 324 integrally formed with the front cover 220. The hinge pin receiver 324 defines a curved “C” shaped configuration.

A sealed relationship is preferably provided between the front cover 220 and the main body 216 when the front cover 220 is in the closed position. For example, in one embodiment, the main body 216 defines a front edge 260 that extends generally around the perimeter of the open front side 218 and cooperates with a corresponding rear edge 326 defined on the back side 328 of the front cover 220 to provide a sealed relationship therebetween. In other embodiments, a gasket can be provided about the perimeter of the open front side 218 so as to provide a seal between the front cover 220 and the main body 216.

A cable/fiber management structure 264 is provided within the interior of the enclosure 202. As shown in FIG. 9, the cable management structure 264 may include a two-layer bend radius limiting structure.

The two bend radius limiters are positioned within the enclosure so as to define spool arrangements configured for allowing excess fiber optic cable to be spooled or looped around the bend radium limiters. A first bend radius limiter 265 is defined integrally with the main body 216 and extends from the rear wall of the main body 216 toward the cover 220. A second bend radius 267 limiter structure extends from the first bend radius limiter structure 265 toward the cover 220 of the fiber access terminal 200. Each of the bend radius limiters 265, 267 defines an outer curved surface having a curvature that satisfies the minimum bend radius requirements of the optical fiber desired to be stored within the enclosure 202.

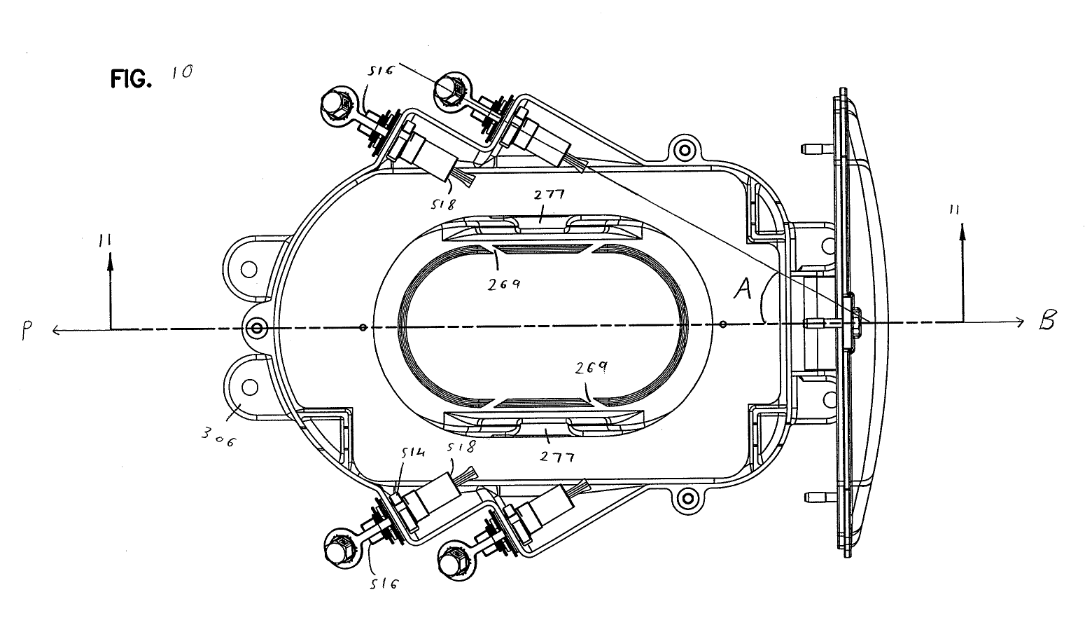

As will be discussed in further detail below, the first bend radius limiter structure 265 defines a space 350 around the first bend radius limiter 265 in cooperation with the top, bottom, right and left sides 208, 210, 212, 214 of the enclosure for routing the main fiber optic cable entering and exiting the fiber access terminal 200. The second bend radius limiting structure 267 manages branched-out fiber optic cables that extend to the connection locations 514 (e.g., fiber optic adapters) located around the periphery of the main body 216 of the fiber access terminal 200. The second bend radius limiting structure 267 defines slits 269 for allowing the cable to pass from one side of the enclosure 202 to the other side for a change of direction in the looping of the cable as shown in FIGS. 12-14.

As shown in FIG. 15, the first bend radius limiting structure 265 defines two channels 277 on opposite sides of the structure for allowing branched out cables to extend from the space 350 around the first bend radius limiting structure 265 to the region defined around the second bend radius limiting structure 267. Two vertical wall members 279 integrally formed adjacent the channels 277 guide the cables toward the channels 277.

The fiber access terminal 200 includes a cable retention member 268 (shown in detail in FIGS. 27-28) that functions to prevent cable looped around the first bend radius limiter 265 from migrating forwardly past the front end of the bend radius limiter 265. The cable retention member 268 is a removable structure and is contoured to fit within the interior of the enclosure 202. The cable retainer 268 is placed between the first and second bend radius limiting structures 265, 267, creating a 2-compartment configuration within the enclosure 202. The cable retention member 268 defines an opening 271 larger than the second bend radius limiter 267 such that branched-out cables extending from the space 350 defined around the first bend radius limiter 265 can reach the layer of the second bend radius limiter 267 after passing through the opposing channels 277.

According to one embodiment, the fiber access terminal 200 is configured to allow the main fiber optic cable to be mounted in a “pass-through” configuration within the enclosure 202. In this “pass-through” configuration, upstream and downstream portions of the cable are routed in and out of the enclosure 202 through the cable enter/exit openings 314, 316, 318 defined at the top side or the bottom side of the fiber access terminal 200. For example, a main cable can enter the fiber access terminal through the first cable enter/exit opening 314. After the excess cable is wrapped around the first bend radius limiter 265 and is retained by the cable retainer 268, the main cable can exit through the second or the third cable enter/exit opening 316, 318. Any combination of the first, second, and third cable enter/exit openings 314, 316, 318 can be used depending upon the desired routing configuration when the cable is routed to and away from the fiber access terminal 200.

In using the fiber access terminal 200 for a mid-span branch-out application, the cable is initially prepared by stripping away the outer jacket of the cable for a desired length and exposing the optic fibers to be branched out. In the depicted embodiment, the enclosure 202 is configured to reroute four optical fibers. The stripped portion of the cable can then be spooled around the second bend radius limiter 267 after passing through the channels 277 provided by the first bend radius limiter 265.

Once the four optic fibers are separated from the main cable 500, the four accessed fibers are field-terminated to field-terminable fiber optic connectors 502. Examples of field-termination techniques for terminating an optical fiber to a fiber optic connector in the field is described in U.S. application Ser. Nos. 11/439,824; 12/359,061; 12/359,003; 12/323,980; and 12/500,188 and U.S. Pat. Nos. 6,811,323; 7,481,585, and 7,490,994, the entire disclosures of which are incorporated herein by reference in their entireties. Other field termination techniques are possible. Excess fiber can be stored by wrapping the excess fiber around the second bend radius limiter 267.

As shown in FIG. 9, a plurality of fiber optic adapters 514 are mounted to the main body 216. Each of the fiber optic adapters 514 includes an inner port 518 positioned inside the internal cavity of the enclosure 202 and an outer port 516 positioned at an outer surface of the main body 216. Referring to FIGS. 10, 12, and 14, the main body 216 defines a first adapter mounting wall 504 on the right side 212 of the enclosure 202 and a second adapter mounting wall 506 at the left side 214 of the enclosure 202. The two fiber optic adapters 514 on each of the first and second mounting walls 504, 506 extend outwardly and downwardly at an acute angle A with respect to a plane P going from the top 208 of the enclosure 202 to the bottom 210 of the enclosure 202. When the fiber access terminal 200 is mounted vertically on, for example, a telephone pole, the fiber optic adapters 514 extend away from the right and left sides 212, 214 and extend downwardly toward the ground. The fiber optic adapters 514 are also arranged such that they are symmetric with respect to a line B bisecting the fiber access terminal to a right half and a left half in a direction going from the top 208 to the bottom 210 of the terminal 200 as seen in FIG. 10.

Of course, as discussed above, the fiber access terminal 200 can be mounted in any orientation as needed by the end user. Therefore, the above mounting configuration is but one example of how the enclosure may be mounted.

The fiber optic adapters 514 mounted to the main body 216 of the fiber access terminal 200 may be hardened fiber optic adapters, examples of which are described in U.S. patent application Ser. No. 12/203,508 and U.S. Pat. Nos. 6,899,467; 6,648,520; and 6,579014, the disclosures of which are incorporated herein by reference in their entireties.

In use of the fiber access terminal 200, fibers from a mid-span access location of a cable passed through the cable exit/enter openings 314, 316, 318 are connectorized by field terminating. The connectorized cables are then inserted within the inner ports 518 of the fiber optic adapters 514. By plugging a connectorized end of a drop cable into an outer port 516 of one of the fiber optic adapters 514, the drop cable can be optically connected to one of the fibers of the cable passed through the fiber access terminal 200. The drop cable can then lead to end subscribers or to other points in the network.

The above specification provides examples of how certain aspects may be put into practice. It will be appreciated that the aspects can be practiced in other ways than those specifically shown and described herein without departing from the spirit and scope of the present disclosure.

What is claimed is:

1. A fiber optic access terminal comprising:
an enclosure defining a top side, a bottom side, a right side and a left side, the enclosure including a main body with an open front side and a rear wall, the enclosure also including a front cover for selectively opening and closing the open front side of the main body, the enclosure defining a cable entrance/exit opening positioned on the main body;
at least one fiber optic adapter mounted on the right side of the enclosure and extending both rightwardly from inside the enclosure toward the outside of the enclosure and downwardly in a direction extending from the top of the enclosure toward the bottom of the enclosure;
at least one fiber optic adapter mounted on the left side of the enclosure and extending both leftwardly from inside the enclosure toward the outside of the enclosure and downwardly in a direction extending from the top of the enclosure toward the bottom of the enclosure; and
a cable management structure positioned between the at least one fiber optic adapter mounted on the right side and the at least one fiber optic adapter mounted on the left side, the cable management structure including a first spool that cooperates with the top side, the bottom side, the right side, and the left side of the enclosure to define a first space extending all the way around the first spool for managing fiber optic cables within the enclosure.

2. A fiber optic access terminal according to claim 1, wherein the at least one fiber optic adapter mounted on the right side of the enclosure includes a pair of fiber optic adapters, each extending both rightwardly and downwardly, the fiber optic adapters mounted on the right side defining parallel axes.

3. A fiber optic access terminal according to claim 1, wherein the at least one fiber optic adapter mounted on the left side of the enclosure includes a pair of fiber optic adapters, each extending both leftwardly and downwardly, the fiber optic adapters mounted on the left side defining parallel axes.

4. A fiber optic access terminal according to claim 2, wherein the at least one fiber optic adapter mounted on the left side of the enclosure includes a pair of fiber optic adapters, each extending both leftwardly and downwardly, the fiber optic adapters mounted on the left side defining parallel axes.

5. A fiber optic access terminal according to claim 1, wherein the cable management structure defines a two-layer structure including the first spool that extends from the rear wall of the main body toward the cover and a second spool that extends from the first spool toward the cover, the second spool also cooperating with the top side, the bottom side, the right side, and the left side of the enclosure to define a second space extending all the way around the second spool for managing fiber optic cables within the enclosure.

6. A fiber optic access terminal according to claim 5, wherein the first spool defines a channel for allowing cables to extend from the first space around the first spool to the second space around the second spool.

7. A fiber optic access terminal according to claim 6, wherein the first spool defines channels on opposing sides of the first spool.

8. A fiber optic access terminal according to claim 5, further comprising a planar cable retention member configured to separate the first space from the second space and configured to prevent cable looped around the first spool from migrating forwardly past a front end of the first spool toward the second spool.

9. A fiber optic access terminal according to claim 5, wherein the second spool defines slits on opposing sides of the spool for allowing cables to pass between the right and left sides of the enclosure.

10. A fiber optic access terminal according to claim 1, wherein the first spool is integrally molded with the main body.

11. A fiber optic access terminal according to claim 1, the enclosure defines first and second cable entrance/exit openings positioned adjacent the top side and a third cable entrance/exit opening adjacent the bottom side

12. A fiber optic access terminal according to claim 11, wherein the first cable entrance/exit opening and the third cable pass entrance/exit opening are axially aligned in a direction from the top side toward the bottom side of the enclosure, wherein any combination of the first, second, and third cable entrance/exit openings can be used for routing fiber optic cables into and out of the enclosure.

13. A fiber optic access terminal according to claim 1, wherein the front cover is hingedly mounted on the main body and is sealably engageable with the main body via a gasket provided around the periphery of the open front side of the main body.

14. A fiber optic access terminal comprising:
an enclosure defining a top side, a bottom side, a right side and a left side, the enclosure including a main body with an open front side and a rear wall, the enclosure also including a front cover hingedly mounted to the main body for selectively opening and closing the open front side of the main body, the enclosure defining first and second fiber optic cable pass-through openings positioned adjacent the top side and a third fiber optic cable pass-through opening adjacent the bottom side, the first fiber optic cable pass-through opening and the third fiber optic cable pass-through opening axially aligned in a direction from the top side toward the bottom side of the enclosure, wherein any combination of the first, second, and third fiber optic cable pass-through openings can be used for routing fiber optic cables into and out of the enclosure;
a first pair of fiber optic adapters mounted on the right side of the enclosure and extending both rightwardly from inside the enclosure toward the outside of the enclosure and downwardly in a direction extending from the top of the enclosure toward the bottom of the enclosure;
a second pair of fiber optic adapters mounted on the left side of the enclosure and extending both leftwardly from inside the enclosure toward the outside of the enclosure and downwardly in a direction extending from the top of the enclosure toward the bottom of the enclosure; and
a cable management structure positioned between the first pair of fiber optic adapters and the second pair of fiber optic adapters, the cable management structure defining a two-layer structure including a first spool that extends from the rear wall of the main body toward the cover and a second spool that extends from the first spool toward the cover, each of the first and second spools cooperating with the top side, the bottom side, the right side, and the left side of the enclosure to define first and second spaces extending all the way around the first and second spools, respectively, for managing fiber optic cables within the enclosure.

15. A fiber optic access terminal according to claim 14, wherein the first spool defines a channel for allowing cables to extend from the first space around the first spool to the second space around the second spool.

16. A fiber optic access terminal according to claim 15, wherein the first spool defines channels on opposing sides of the first spool.

17. A fiber optic access terminal according to claim 14, wherein the front cover is sealably engageable with the main body via a gasket provided around the periphery of the open side of the main body.

18. A fiber optic access terminal according to claim 14, wherein the first spool is integrally molded with the main body.

19. A fiber optic access terminal according to claim 14, further comprising a planar cable retention member configured to separate the first space from the second space and configured to prevent cable looped around the first spool from migrating forwardly past a front end of the first spool toward the second spool.

20. A fiber optic access terminal according to claim 14, wherein the second spool defines slits on opposing sides of the spool for allowing cables to pass between the right and left sides of the enclosure.
